(19) United States
(12) Patent Application Publication
(10) Pub. No.: US 2019/0368315 A1
(43) Pub. Date: Dec. 5, 2019

(54) POWER SUPPLY FOR OFFSHORE EQUIPMENT AND OPERATIONS

(71) Applicant: Saudi Arabian Oil Company, Dhahran (SA)

(72) Inventors: Mohamed Y. HAJ-MAHARSI, Dhahran (SA); Ahd H. GHEETH, Dhahran (SA)

(21) Appl. No.: 16/000,704

(22) Filed: Jun. 5, 2018

(51) Int. Cl. E21B 41/00; H02J 3/32; E21B 43/12

(52) U.S. Cl. CPC E21B 41/0007; H02M 7/42; E21B 43/128; H02J 3/32

(57) ABSTRACT

The present disclosure describes methods and systems for providing power to an offshore platform. In one implementation, an offshore includes: an electrical energy storage device connected to a load on the offshore platform; and a diode comprising a first terminal and a second terminal, wherein the first terminal is connected to the load and a positive terminal of the electrical energy storage device, the second terminal is connected to a power cable, the power cable is connected to an onshore power supply system, and the diode is configured to direct electric current to flow from the power cable to the load and prevent electric current to flow from the electrical energy storage device to the power cable.

### TECHNICAL FIELD

This disclosure relates to power supply for offshore equipment and operations.

### BACKGROUND

In the oil and gas industry, an offshore drilling operation is a process where a wellbore is drilled below the seabed. The operation can be carried out in order to explore for, and subsequently extract, petroleum which lies in rock formations beneath the seabed. Offshore drilling can be carried out by offshore platforms. An offshore platform may be fixed to the ocean floor or float on the surface of ocean. Once drilling is completed, the oil platform can be used to pump oil from the well to the surface, and later to the processing facility.

### SUMMARY

The present disclosure describes providing power to an offshore platform. In an implementation, an offshore platform includes: an electrical energy storage device connected to a load on the offshore platform; and a diode comprising a first terminal and a second terminal, wherein the first terminal is connected to the load and a positive terminal of the electrical energy storage device, the second terminal is connected to a power cable, the power cable is connected to an onshore power supply system, and the diode is configured to direct electric current to flow from the power cable to the load and prevent electric current to flow from the electrical energy storage device to the power cable.

In another implementation, a method of providing power supply to an offshore platform includes: providing, from an onshore power supply system, electrical power to a load on the offshore platform through a power cable, wherein the power cable is connected to a diode, the diode comprises a first terminal and a second terminal, the first terminal is connected to the load and a positive terminal of an electrical energy storage device installed on the offshore platform, the second terminal is connected to the power cable, and the diode is configured to direct electric current to flow from the power cable to the load and prevent electric current from flowing from the electrical energy storage device to the power cable; and when an upstream fault occurs, providing, from the electrical energy storage device, direct current (DC) power to the load on the offshore platform, wherein the upstream fault comprises a fault in the power cable or the onshore power supply system.

In yet another implementations, a power supply system for offshore operations includes an onshore power supply system comprising a power supply that generates electrical power; a power cable connected to the onshore power supply system, wherein the power cable is configured to transmit the electrical power generated from the onshore power supply system; and an offshore platform including an electrical energy storage device connected to a load on the offshore platform; and a diode comprising a first terminal and a second terminal, wherein the first terminal is connected to the load and a positive terminal of the electrical energy storage device, the second terminal is connected to the power cable, and the diode is configured to direct electric current to flow from the power cable to the load and prevent electric current to flow from the electrical energy storage device to the power cable.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIG. 1 is a schematic diagram that illustrates an example power supply system for offshore operations, according to an implementation.

FIG. 2 is a chart illustrating an example simulation for the branch circuit feeding the alternating current (AC) load where the incoming direct current (DC) power is inverted to AC through an inverter, according to an implementation.

FIG. 3 is a chart illustrating an example simulation of the direct current (DC) load for an offshore platform during a fault, according to an implementation.

Like reference numbers and designations in the various drawings indicate like elements.

### DETAILED DESCRIPTION

The following detailed description describes providing power supply to an offshore platform and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail inasmuch as such details are within the skill of one of ordinary skill in the art. The present disclosure is not intended to be limited to the described or illustrated implementations, but to be accorded the widest scope consistent with the described principles and features.

In some implementations, electrical submersible pumps (ESPs) can be been used in oil operations. An ESP includes a sealed motor close-coupled to the pump body. The ESP can be submerged in the fluid to be pumped an ESP pushes fluids to the surface, which improves the efficiency of the operations. ESP has been implemented in both onshore and offshore platforms to improve the reservoir recovery factor and increase production.

In an offshore oil platform, the ESP can be powered by a direct current (DC) power supply system. The ESP is installed on an offshore platform. The power supply is installed onshore. The onshore power supply source is connected with the offshore platform by power transmission cables. Because of the long distance between the offshore platform and the onshore platform (sometimes in the range of several hundred kilometers), transmitting the electrical power using DC over the power transmission cable can be a more efficient than using alternating current (AC). Moreover, DC power supply is generally more reliable than AC power supply. Accordingly, it is beneficial to configure the loads on the offshore platform, including the ESP, to be powered by the DC power supply.

The reliability of the power supply can be further improved by installing a battery system, or any other energy storage devices, such as capacitors and super capacitors on the offshore platform to supplement the DC power supply on the onshore platform. In the case that a fault in the electrical system occurs between the onshore and offshore platform, the battery can supply the power to the ESP or other equipment on the offshore platform while the fault is being fixed. The battery or other energy storage devices can also be used to supply power to other equipment on the offshore platforms, including but not limited to: oil platforms, water supply, and other fluid pumping platforms. The battery or other energy storage devices can be used to supply power to offshore operations, including but not limited to: drilling operation, oil and gas extraction, and water injection. Furthermore, a diode can be used to regulate the direction of the current provided by the battery system or other energy storage device. The current can be directed to the loads on the offshore platform during the upstream power disturbances, instead of flowing upstream to the fault.

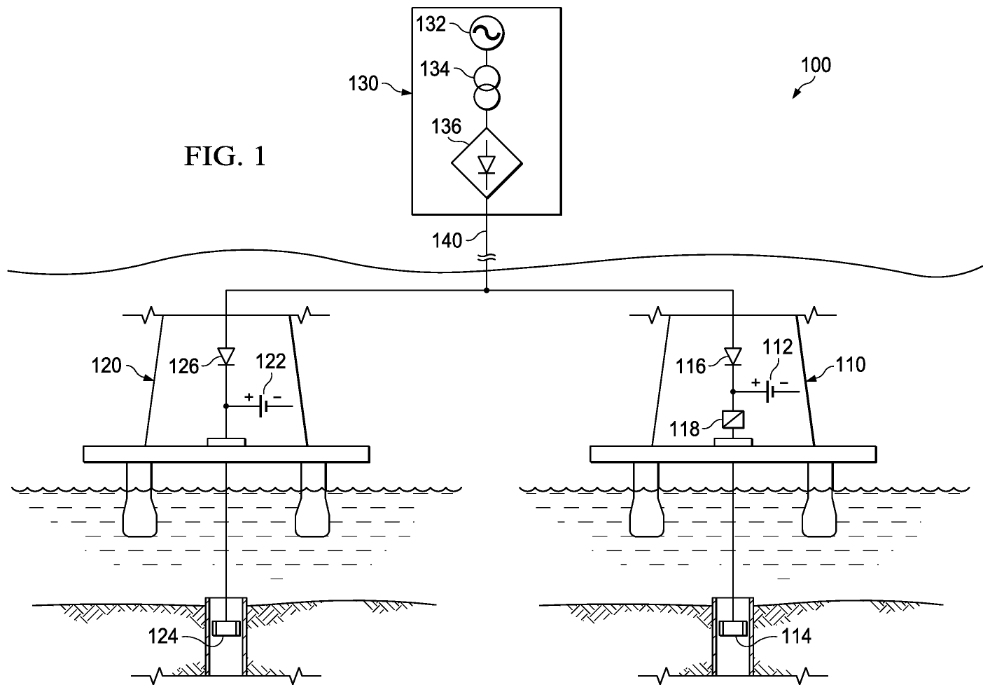

FIG. 1 is a schematic diagram that illustrates an example power supply system 100 for offshore drilling operations, according to an implementation. At a high level, the system 100 includes an onshore platform 130 that is connected with offshore platforms 110 and 120 over a cable 140. The described illustration is one possible implementation of the described subject matter and is not intended to limit the disclosure to the single described implementation. Those of ordinary skill in the art will appreciate the fact that the described components can be connected, combined, or used in alternative ways consistent with this disclosure.

The onshore platform 130 includes an AC power supply 132, a transformer 134, and a rectifier 136. The AC power supply 132 can be any devices that generate AC. The AC power supply 132 can include one or more generators. The AC power supply 132 can be powered by gas, coal, oil, wind, solar, or any other source of power.

The transformer 134 connects the AC power supply 132 with the rectifier 136. The transformer 134 is configured to reduce the voltage generated by the AC power supply 132 to the operating range of the rectifier 136. In some implementations, the transformer 134 can be implemented by one transformer, or an array of transformers.

The rectifier 136 converts the AC power generated by the AC power supply 132 to DC. The AC power supply 132, the transformer 134, and the rectifier 136 form an onshore DC power supply system that provides DC power to the offshore platforms. In some cases, the onshore DC power supply system can include additional components, for example, one or more electronic filters, capacitors, chokes, resistors, voltage regulators, or any combinations thereof.

The cable 140 represents a DC link cable that transmits DC from the onshore platform 130 to the offshore platforms 110 and 120. The cable 140 can include one or more electrical conductors that are held together with an overall sheath. To support offshore operations, the cable 140 uses materials that can withstand challenging environmental conditions, such as cold, high heat, humidity, pressure, chemical exposure (minerals and esters), sunlight, and long operating durations In some cases, the length of the cable 140 can be hundreds of kilometers.

In some implementations, the onshore platform 130 can supply AC power to the offshore platforms 110 and 120 instead of DC power as described previously. For example, instead of including the rectifier 136 in the onshore platform 130, each of the offshore platforms 110 and 120 can include a rectifier that converts AC to DC. Correspondingly, the cable 140 can represent an AC cable that transmits AC from the onshore platform 130 to the rectifiers on the offshore platforms 110 and 120.

The offshore platforms 110 and 120 represent offshore platforms that perform offshore operations. Examples of the offshore operations include drilling operations, oil extraction operations, water injection. The offshore platform 110 includes a battery 112 that is connected with a diode 116 and an inverter 118. The inverter 118 further connects to an AC motor, or other AC loads, 114.

The battery 112 provides DC power to the equipment on the offshore platform 110 during an electric fault, for example, a short circuit in the onshore power supply system or a break in the cable 140. In some implementations, the battery 112 can be charged by the onshore power supply system when there are no electric faults. In some implementations, the battery 112 can be replaced by other energy storage devices, such as capacitors and supercapacitors.

The diode 116 regulates the direction of the DC supplied by the battery 112. The diode 116 is configured to support the power rating of the electrical loads on the offshore platform. The power rating range can extend from a few watts to the order of megawatts. For ESP application, the typical power ranges from few horsepower (HP), for example, on the order of 20 HP, to hundreds of HP The diode 116 has an incoming terminal that is connected to the cable 140 and an outgoing terminal that is connected to the positive terminal of the battery 112 and the load on the offshore platform 110 (for example the inverter 118). The diode 116 has asymmetric conductance. The diode 116 permits electric current to flow from the incoming terminal to the outgoing terminal, but blocks electric current to flow in the opposite direction. Therefore, the diode 116 directs the DC to flow from the cable 140 to the loads on the offshore platform 110, including, for example, the inverter 118 during normal operation. However, when a fault in the upstream circuit, for example the cable 140 or the onshore power supply system, occurs, the diode 116 blocks the DC to flow from the battery 112 to the cable 140. Accordingly, stable power supply to the offshore platform 110 can be maintained when a fault occurs.

In some operations, the equipment on offshore platforms can use AC power. As illustrated, the offshore platform 110 includes the inverter 118 that changes DC to AC. As described previously, the DC is supplied by the onshore power supply system through the cable 140 during normal operation, and by the battery 112 when an electrical fault occurs. The AC can be used to power the AC motor 114 or other AC loads. The AC motor 114 can be a component of an ESP that operates underwater in a wellhead. The offshore platform 110 can include other electric equipment that uses AC power.

Alternatively, the equipment on offshore platforms can use DC power. As illustrated, the offshore platform 120 includes a battery 122 that is connected with a diode 126 and a DC motor 124. Similarly to the offshore platform 110, the battery 122 provides the DC when an electrical fault occurs. The diode 126 regulates the current to flow from the cable 140 to the offshore platform 120, but blocks the current from flowing from the battery 122 to the cable 140. On the offshore platform 120, the DC is used to power the DC motor 124 or other DC loads, which can be a component of an ESP that operates underwater in a wellhead. The offshore platform 120 can include other electric equipment that uses DC power. In some cases, an offshore platform can include both equipment that uses AC power and equipment that uses DC power.

While elements of FIG. 1 are shown as including various component parts, portions, or modules that implement the various features and functionality, nevertheless, these elements may, instead, include a number of sub-modules, third-party services, components, and such, as appropriate. Furthermore, the features and functionality of various components can be combined into fewer components, as appropriate.

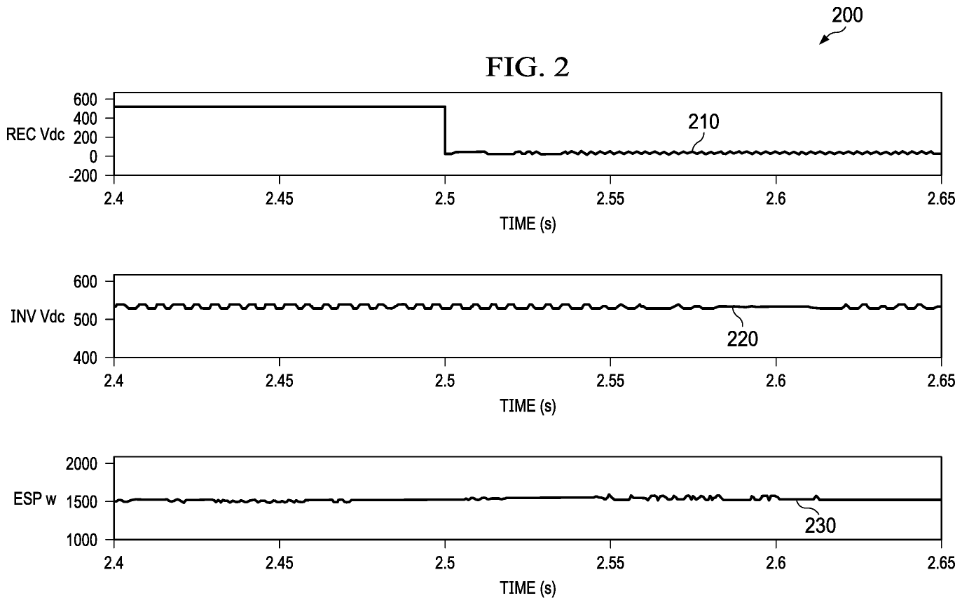

FIG. 2 is a chart 200 illustrating an example simulation of the AC load for an offshore platform during a fault, according to an implementation. The offshore platform can be the offshore platform 110 in FIG. 1, which includes equipment that uses AC power. As illustrated, during an electric fault, the receiving voltage curve 210 shows that the voltage of DC power received from the onshore power supply drops from the operating voltage at about 500 volts to about 0 volt. However, curves 220 and 230, which represent the voltage at the inverter and at the ESP, respectively, remain unchanged. This indicates that the power supply on the offshore platform is steady during the fault.

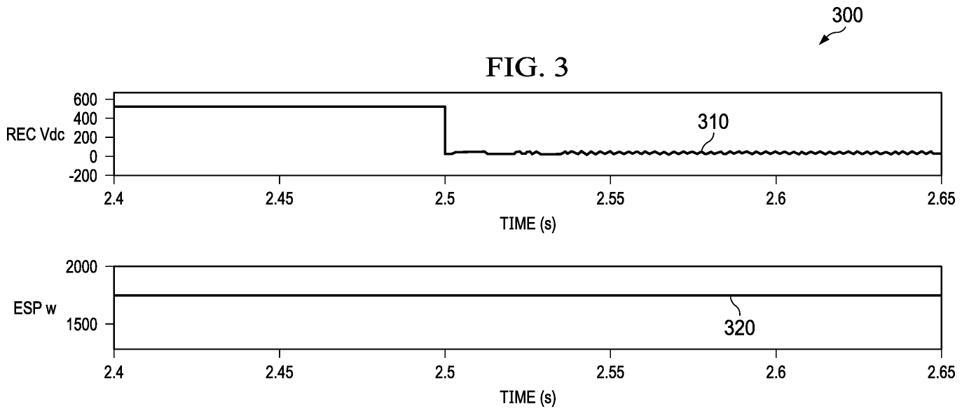

FIG. 3 is a chart 300 illustrating an example simulation of the DC load for an offshore platform during a fault, according to an implementation. The offshore platform can be the offshore platform 120 in FIG. 1, which includes equipment that uses DC power. Similarly to FIG. 2, the receiving voltage curve 310 shows that the voltage of DC power received from the onshore power supply drops during a fault. The curve 320, which represent the voltage at the ESP, indicates that the power supply on the offshore platform is steady during the fault.

Described implementations of the subject matter can include one or more features, alone or in combination.

For example, in a first implementation, a method of providing power supply to an offshore platform includes: providing, from an onshore power supply system, electrical power to a load on the offshore platform through a power cable, wherein the power cable is connected to a diode, the diode comprises a first terminal and a second terminal, the first terminal is connected to the load and a positive terminal of an electrical energy storage device installed on the offshore platform, the second terminal is connected to the power cable, and the diode is configured to direct electric current to flow from the power cable to the load and prevent electric current from flowing from the electrical energy storage device to the power cable; and when an upstream fault occurs, providing, from the electrical energy storage device, direct current (DC) power to the load on the offshore platform, wherein the upstream fault comprises a fault in the power cable or the onshore power supply system.

The foregoing and other described implementations can each, optionally, include one or more of the following features:

A first feature, combinable with any of the following features, wherein the power cable transmits direct current (DC) from the onshore power supply system to the offshore platform.

A second feature, combinable with any of the previous or following features, wherein the load comprises an electrical submersible pump (ESP) that is configured to pump fluid.

A third feature, combinable with any of the previous or following features, wherein the ESP is powered by DC power.

A fourth feature, combinable with any of the previous or following features, wherein the ESP is powered by alternating current (AC) power.

A fifth feature, combinable with any of the previous or following features, wherein the load comprises an inverter that converts DC to AC.

A sixth feature, combinable with any of the previous or following features, wherein the electrical energy storage device is a battery.

A seventh feature, combinable with any of the previous or following features, wherein the power cable transmits alternative current (AC) from the onshore power supply system to the offshore platform.

An eighth feature, combinable with any of the previous or following features, wherein the offshore platform comprises a rectifier that is configured to covert AC to DC.

In a second implementation, a method of providing power supply to an offshore platform includes providing, from an onshore power supply system, electrical power to a load on the offshore platform through a power cable, wherein the power cable is connected to a diode, the diode comprises a first terminal and a second terminal, the first terminal is connected to the load and a positive terminal of an electrical energy storage device installed on the offshore platform, the second terminal is connected to the power cable, and the diode is configured to direct electric current to flow from the power cable to the load and prevent electric current from flowing from the electrical energy storage device to the power cable; and when an upstream fault occurs, providing, from the electrical energy storage device, direct current (DC) power to the load on the offshore platform, wherein the upstream fault comprises a fault in the power cable or the onshore power supply system.

The foregoing and other described implementations can each, optionally, include one or more of the following features:

A first feature, combinable with any of the following features, wherein the load comprises an electrical submersible pump (ESP) that is configured to pump fluid.

A second feature, combinable with any of the previous or following features, wherein the ESP is powered by DC power.

A third feature, combinable with any of the previous or following features, wherein the ESP is powered by alternating current (AC) power.

A fourth feature, combinable with any of the previous or following features, wherein the load comprises an inverter that converts DC to AC.

A fifth feature, combinable with any of the previous or following features, wherein the electrical energy storage device is a battery.

A sixth feature, combinable with any of the following features, wherein the power cable is a DC power cable and the electrical power is provided in DC.

A seventh feature, combinable with any of the following features, wherein the power cable is an AC power cable and the electrical power is provided in AC.

An eighth feature, combinable with any of the following features, wherein the offshore platform comprises a rectifier that is configured to covert AC to DC.

In a third implementation, a power supply system for offshore operations includes an onshore power supply system comprising a power supply that generates electrical power; a power cable connected to the onshore power supply system, wherein the power cable is configured to transmit the electrical power generated from the onshore power supply system; and an offshore platform including an electrical energy storage device connected to a load on the offshore platform; and a diode comprising a first terminal and a second terminal, wherein the first terminal is connected to the load and a positive terminal of the electrical energy storage device, the second terminal is connected to the power cable, and the diode is configured to direct electric current to flow from the power cable to the load and prevent electric current to flow from the electrical energy storage device to the power cable.

The foregoing and other described implementations can each, optionally, include one or more of the following features:

A first feature, combinable with any of the following features, wherein the power cable transmits direct current (DC) from the onshore power supply system to the offshore platform.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Accordingly, the previously described example implementations do not define or constrain this disclosure. Other changes, substitutions, and alterations are also possible without departing from the spirit and scope of this disclosure.

What is claimed is:

1. An offshore platform, comprising:
an electrical energy storage device connected to a load on the offshore platform; and
a diode comprising a first terminal and a second terminal, wherein the first terminal is connected to the load and a positive terminal of the electrical energy storage device, the second terminal is connected to a power cable, the power cable is connected to an onshore power supply system, and the diode is configured to direct electric current to flow from the power cable to the load and prevent electric current to flow from the electrical energy storage device to the power cable.

2. The offshore platform of claim 1, wherein the power cable transmits direct current (DC) from the onshore power supply system to the offshore platform.

3. The offshore platform of claim 1, wherein the load comprises an electrical submersible pump (ESP) that is configured to pump fluid.

4. The offshore platform of claim 3, wherein the ESP is powered by DC power.

5. The offshore platform of claim 3, wherein the ESP is powered by alternating current (AC) power.

6. The offshore platform of claim 5, wherein the load comprises an inverter that converts DC to AC.

7. The offshore platform of claim 1, wherein the electrical energy storage device is a battery.

8. The offshore platform of claim 1, wherein the power cable transmits alternative current (AC) from the onshore power supply system to the offshore platform.

9. The offshore platform of claim 8, wherein the offshore platform comprises a rectifier that is configured to covert AC to DC.

10. A method of providing power supply to an offshore platform, comprising:
providing, from an onshore power supply system, electrical power to a load on the offshore platform through a power cable, wherein the power cable is connected to a diode, the diode comprises a first terminal and a second terminal, the first terminal is connected to the load and a positive terminal of an electrical energy storage device installed on the offshore platform, the second terminal is connected to the power cable, and the diode is configured to direct electric current to flow from the power cable to the load and prevent electric current from flowing from the electrical energy storage device to the power cable; and
when an upstream fault occurs, providing, from the electrical energy storage device, direct current (DC) power to the load on the offshore platform, wherein the upstream fault comprises a fault in the power cable or the onshore power supply system.

11. The method of claim 10, wherein the load comprises an electrical submersible pump (ESP) that is configured to pump fluid from a well.

12. The method of claim 11, wherein the ESP is powered by DC power.

13. The method of claim 11, wherein the ESP is powered by alternating current (AC) power.

14. The method of claim 13, further comprising converting DC power to AC power.

15. The method of claim 10, wherein the electrical energy storage device is a battery

16. The method of claim 10, wherein the power cable is a DC power cable and the electrical power is provided in DC.

17. The method of claim 10, wherein the power cable is an AC power cable and the electrical power is provided in AC.

18. The method of claim 17, wherein the offshore platform comprises a rectifier that is configured to covert AC to DC.

19. A power supply system for offshore operations, comprising:
an onshore power supply system comprising a power supply that generates electrical power;
a power cable connected to the onshore power supply system, wherein the power cable is configured to transmit the electrical power generated from the onshore power supply system; and
an offshore platform, comprising:
an electrical energy storage device connected to a load on the offshore platform; and
a diode comprising a first terminal and a second terminal, wherein the first terminal is connected to the load and a positive terminal of the electrical energy storage device, the second terminal is connected to the power cable, and the diode is configured to direct electric current to flow from the power cable to the load and prevent electric current to flow from the electrical energy storage device to the power cable.

20. The power supply system of claim 19, wherein the power cable transmits direct current (DC) from the onshore power supply system to the offshore platform.
